(19) United States
(12) Patent Application Publication
(10) Pub. No.: US 2025/0184895 A1
(43) Pub. Date: Jun. 5, 2025

(54) INFORMATION TRANSMISSION METHOD AND APPARATUS, RECEIVING END, AND SENDING END

(71) Applicant: VIVO MOBILE COMMUNICATION CO., LTD., Dongguan (CN)

(72) Inventors: Dongru LI, Dongguan (CN); Kai WU, Dongguan (CN)

(73) Assignee: VIVO MOBILE COMMUNICATION CO., LTD., Dongguan (CN)

(21) Appl. No.: 19/044,719

(22) Filed: Feb. 4, 2025

Related U.S. Application Data
(63) Continuation of application No. PCT/CN2023/110691, filed on Aug. 2, 2023.

(30) Foreign Application Priority Data
Aug. 5, 2022 (CN) 202210938832.2

(51) Int. Cl. H04W 52/02; H04L 1/00; H04W 24/08

(52) U.S. Cl. CPC H04W 52/0229; H04L 1/0061; H04W 24/08

(57) ABSTRACT

This application provides an information transmission method and apparatus, a receiving end, and a sending end. The information transmission method includes: a receiving end receives at least one information block; and the receiving end obtains first data based on the at least one information block. The first data includes at least one of the following: a wake-up signal or information of backscatter communication.

### CROSS-REFERENCE TO RELATED APPLICATIONS

This application is a continuation of International Application No. PCT/CN 2023/110691, filed on Aug. 2, 2023, which claims priority to Chinese Patent Application No. 202210938832.2, filed on Aug. 5, 2022. The entire contents of each of the above-referenced applications are expressly incorporated herein by reference.

### TECHNICAL FIELD

This application belongs to the field of communication technologies, and in particular, to an information transmission method and apparatus, a receiving end, and a sending end.

### BACKGROUND

In a Time Division Duplex (TDD) scenario, there are no continuous downlink or uplink resources due to uplink and downlink time division multiplexing. This imposes a great limitation on implementation of complete information transmission that requires occupation of continuous uplink or downlink resources.

### SUMMARY

Embodiments of this application provide an information transmission method and apparatus, a receiving end, and a sending end, to implement discontinuous transmission of information.

According to a first aspect, an information transmission method is provided, including:

A receiving end receives at least one information block; and
the receiving end obtains first data based on the at least one information block, where
the first data includes at least one of the following: a wake-up signal and information of backscatter communication.

In a second aspect, an information transmission apparatus is provided, including:
a first receiving module, configured to receive at least one information block; and
a first obtaining module, configured to obtain first data based on the at least one information block, where
the first data includes at least one of the following: a wake-up signal and information of backscatter communication.

According to a third aspect, an information transmission method is provided, including:

A sending end splits first data to be sent into at least one sub-block; and
the sending end sends at least one information block to a receiving end based on the at least one sub-block, where the at least one information block is used for the receiving end to obtain the first data, and
the first data includes at least one of the following: a wake-up signal and information of backscatter communication.

In a fourth aspect, an information transmission apparatus is provided, including:
a splitting module, configured to split first data to be sent into at least one sub-block; and
a first sending module, configured to send at least one information block to a receiving end based on the at least one sub-block, where the at least one information block is used for the receiving end to obtain the first data, and
the first data includes at least one of the following: a wake-up signal and information of backscatter communication.

According to a fifth aspect, a receiving end is provided. The receiving end includes a processor and a memory, the memory stores a program or instructions that may be run on the processor, and the program or the instructions, when executed by the processor, enable the steps of the method according to the first aspect to be implemented.

According to a sixth aspect, a receiving end is provided, including a processor and a communication interface. The communication interface is configured to: receive at least one information block; and obtain first data based on the at least one information block, where
the first data includes at least one of the following: a wake-up signal and information of backscatter communication.

According to a seventh aspect, a sending end is provided, including a processor and a memory. The memory stores a program or instructions that may be run on the processor, and the program or the instructions, when executed by the processor, enable the steps of the method according to the first aspect to be implemented.

According to an eighth aspect, a sending end is provided, including a processor and a communication interface. The communication interface is configured to: split first data to be sent into at least one sub-block; and send at least one information block to a receiving end based on the at least one sub-block, where the at least one information block is used for the receiving end to obtain the first data, and
the first data includes at least one of the following: a wake-up signal and information of backscatter communication.

According to a ninth aspect, an information transmission system is provided, including: a receiving end and a sending end. The receiving end may be configured to perform the steps of the information transmission method according to the first aspect, and the sending end may be configured to perform the steps of the information transmission method according to the third aspect.

According to a tenth aspect, a readable storage medium is provided. The readable storage medium stores a program or instructions. The program or instructions, when executed by a processor, enable the steps of the method according to the first aspect or the steps of the method according to the third aspect to be implemented.

According to an eleventh aspect, a chip is provided. The chip includes a processor and a communication interface. The communication interface is coupled to the processor. The processor is configured to run a program or instructions to implement the method according to the first aspect, or implement the method according to the third aspect.

According to a twelfth aspect, a computer program/program product is provided. The computer program/program product is stored in a storage medium. The computer program/program product is executed by at least one processor to implement the steps of the method according to the first aspect or the third aspect.

In embodiments of this application, by receiving at least one information block associated with a wake-up signal and/or information of backscatter communication, a receiving end can obtain the wake-up signal and/or the information of the backscatter communication based on the at least one information block, thereby implementing discontinuous transmission of the wake-up signal and/or the information of the backscatter communication in time domain.

### BRIEF DESCRIPTION OF THE DRAWINGS

FIG. 1 is a block diagram of a wireless communication system to which an embodiment of this application is applicable;

FIG. 2 is a diagram of a working principle of NR LP WUR/WUS;

FIG. 3 is a diagram of a time domain pattern of on-off-keying;

FIG. 4 is a schematic flowchart 1 of an information transmission method according to an embodiment of this application;

FIG. 5 is a diagram of control command splitting;

FIG. 6 is a diagram of distribution positions of a preamble sequence, a synchronization sequence, and a CRC sequence in a middle information block;

FIG. 7 is a diagram of distribution positions of a preamble sequence and a synchronization sequence in a middle information block;

FIG. 8 is a diagram of a distribution position of a CRC sequence in a middle information block;

FIG. 9 is a diagram 1 of a process in which a sending end and a receiving end implement transmission of a control command for backscatter communication;

FIG. 10 is a diagram 2 of a process in which a sending end and a receiving end implement transmission of a control command for backscatter communication;

FIG. 11 is a diagram 3 of a process in which a sending end and a receiving end implement transmission of a control command for backscatter communication;

FIG. 12 is a schematic flowchart 2 of an information transmission method according to an embodiment of this application;

FIG. 13 is a diagram 1 of modules of an information transmission apparatus according to an embodiment of this application;

FIG. 14 is a diagram 1 of a structure of a receiving end according to an embodiment of this application;

FIG. 15 is a diagram 2 of a structure of a receiving end according to an embodiment of this application;

FIG. 16 is a diagram 2 of modules of an information transmission apparatus according to an embodiment of this application; and

FIG. 17 is a diagram of a structure of a communication device according to an embodiment of this application.

### DETAILED DESCRIPTION

The following clearly describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application shall fall within the protection scope of this application.

In this specification and claims of this application, the terms “first”, “second”, and the like are intended to distinguish between similar objects but do not indicate a specific order or sequence. It should be understood that terms used in this way are interchangeable in appropriate circumstances, so that embodiments of this application can be implemented in other orders than the order illustrated or described herein. In addition, objects distinguished by “first” and “second” are usually objects of one class with the number of objects unlimited. For example, a first object can indicate one or more first objects. In addition, “and/or” in this specification and the claims indicates at least one of connected objects, and the character “/” generally indicates an “or” relationship between associated objects.

It is worth pointing out that the technology described in embodiments of this application is not limited to a Long Term Evolution (LTE)/LTE-Advanced (LTE-A) system, and can also be used in other radio communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA) and other systems. The terms “system” and “network” in embodiments of this application are often used interchangeably, and the described technology can be applied to the systems and radio technologies mentioned above, and can be also applied to other systems and radio technologies. The following description describes a new radio (NR) system for illustration, and NR terminology is used in most of the following descriptions, but these technologies can also be applied to applications other than NR system applications, such as 6th Generation (6G) communication systems.

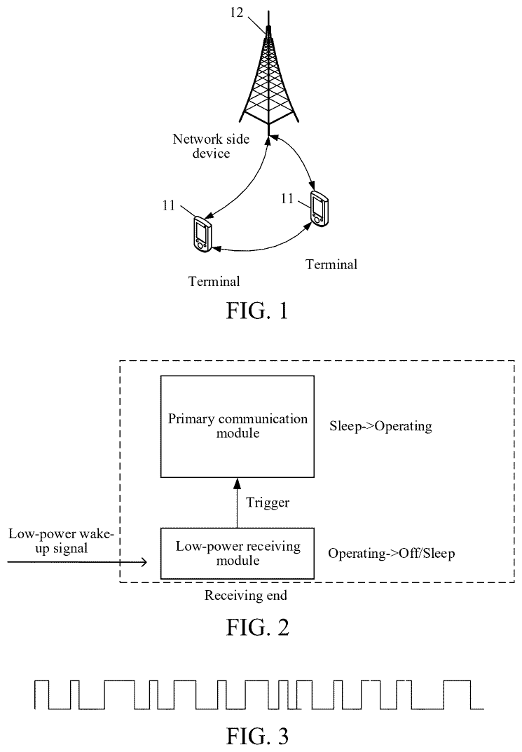

FIG. 1 is a block diagram of a wireless communication system to which an embodiment of this application is applicable. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), smart home (home devices with a wireless communication function, such as a refrigerator, a television, and a washing machine, or furniture), a game console, a personal computer (PC), a teller machine, or a self-service machine. The wearable device includes: a smart watch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. It should be noted that a specific type of the terminal 11 is not limited in embodiments of this application. The network side device 12 may include an access network device or a core network device. The access network device may also be referred to as a radio access network device, a Radio Access Network (RAN), a radio access network function, or a radio access network element. The access network device may include a base station, a Wireless Local Area Network (WLAN) access point, a Wireless Fidelity (Wi-Fi) node, or the like. The base station may be referred to as a node B, an Evolved Node B (eNB), an access point, a Base Transceiver Station (BTS), a radio base station, a radio transceiver, a Basic Service Set (BSS), an Extended Service Set (ESS), a home node B, a home evolved node B, a Transmitting Receiving Point (TRP), or other appropriate terms in the art. The base station is not limited to a specified technical term, provided that a same technical effect is achieved. It should be noted that, in this embodiment of this application, only a base station in an NR system is used as an example for description, and a specific type of the base station is not limited.

Related terms in embodiments of this application are described below.

### I. Backscatter Communication (BSC)

Backscatter communication is that a backscatter communication device transmits its own information through signal modulation by using a radio frequency signal from another device or in an environment. The backscatter communication device may be:
a backscatter communication device in conventional RFID, which is usually a tag, and is a passive Internet of Things (IoT) device (Passive-IoT);
a semi-passive tag, where downlink reception or uplink reflection of such tag has a specific amplification capability; and
a tag (active tag) with an active sending capability, where such tag may send information to a reader without relying on reflection of an incident signal.

In this embodiment, the backscatter communication includes transmission of the following content:

(1) an excited carrier wave (CW); in an embodiment, the excited carrier wave may be sent by a network side device to a tag, or may be sent by a terminal to the tag; and

(2) a control command, for example, a select command, a query command, a repeat query command, an acknowledgment command, a read command, a write command, a random request command, or the like; in an embodiment, the control command may be sent by a network side device to a tag, or may be sent by a terminal to the tag.

For example, the control command may include at least one of the following: a selection type command, a query type command, and an access command. The selection type command includes at least one of the following: a select command (a specific select command), an inventory command, and a sort command. The query type command includes at least one of the following: a query command (a specific query command), a query adjust command, and a query repeat command. The access command includes at least one of the following: a random request command, a read command, a write command, a kill command, a lock command, an access command, a security-related access command, and a file management-related access command.

The selection type (Select) command is necessary. Because a tag has a plurality of attributes, based on a standard and a policy set by a user, using the selection type command, a specific tag group is manually selected or delimited by changing some attributes and flags, and only inventory recognition or access operations may be performed on the specific tag group. This helps reduce conflicts, repeated recognition, and accelerate a recognition speed.

A command of an inventory phase is used to start a process of inventory. For example, the query command is used to start a process of inventory, and determine tags that participate in the process of inventory. The query adjust command is used to adjust a quantity of original receiving slots of a tag. The query repeat command is used to reduce the number of slots of a tag.

In the access command, a random request (Req_RN) command requests a tag to generate a random number. The read command is used to read data from a position in storage of a tag. The write command is used to write data into storage of a tag. The kill command may prevent leakage of privacy, and a tag cannot be used anymore. The lock command is used to disable further writing to a tag, preventing data from being arbitrarily changed. The access command is used to switch a tag from an open state to a secure state when the tag has a password. The security-related access command is used to ensure security of a tag. The file management-related access command may be used to manage a file in a tag.

(3) Information carried by a tag reflection signal (also referred to as backscattering information), including, for example, tag identification information (for example, a 16-bit random number temporarily representing a tag identity in a query process), electronic product code information, and tag status information. In an embodiment, a backscattering channel or signal may be sent by a tag to a terminal through backscattering, or may be sent by a tag to a network side device through backscattering.

### II Backscatter Communication Application Scenario

Backscatter communication may include the following scenarios.
1. A network sends a CW and signaling, and receives a tag reflection signal.
2. A terminal sends a CW and signaling, and receives a tag reflection signal.
3. A network sends a CW and signaling to a tag, and a terminal receives backscattering information sent by the tag.
4. A terminal sends a CW and signaling to a tag, and a network receives backscattering information of the tag.

### III Low Power Receiver

A low power receiver is a low power wake-up radio (LP-WUR). A basic working principle of the LP-WUR is that a receiving end includes a first module and a second module. For example, as shown in FIG. 2, the first module is a main communication module configured to send and receive mobile communication data, and the second module is a low power receiving module (also referred to as a low power wake-up receiving module) configured to receive a wake-up signal. A terminal in an energy saving state turns on the low power receiving module to monitor the LP-WUS, and turns off the main communication module. When downlink data arrives, a network sends a wake-up signal to the terminal. After monitoring the wake-up signal through the low power receiving module, the terminal triggers, through a series of determining, the main communication module to switch from an off state to an on state. In this case, the low power receiving module enters an off state from an operating state. The low power wake-up receiving module may be continuously enabled or intermittently enabled. When enabled, the low power wake-up receiving module may receive a low power wake-up signal.

### IV Low Power Wake-Up Signal

To reduce reception activity of a terminal in a standby state and truly disable a Radio Frequency (RF) module and a baseband (MODEM) module, thereby significantly reducing power consumption of communication reception, a receiver with near-“zero” power may be provided in a receiving module of the terminal. The receiver with near-“zero” power does not require complex signal detection (such as amplification, filtering, and quantization) of the RF module and signal processing of the MODEM module, but only relies on passive matched filtering and signal processing with low power consumption.

On a base station side, a wake-up signal is triggered on demand, so that the receiver with near-“zero” power can be activated to learn of an activated notification, to trigger a series of processes in the terminal, for example, turning on a radio frequency transceiver module, a baseband processing module, and the like.

This wake-up signal is usually some simple on-off keying signals, and a time domain pattern of the on-off keying signal is shown in FIG. 3. In this way, the receiver can learn of a wake-up notification through simple energy detection and subsequent possible processes such as sequence detection and recognition. In addition, when the terminal turns on the low power wake-up receiver to receive the wake-up signal, the main receiver module may maintain operating at a relatively low power consumption level, thereby achieving power consumption saving by receiving the wake-up signal.

An information transmission method and apparatus, a receiving end, and a sending end provided in embodiments of this application are described in detail below with reference to the accompanying drawings through some embodiments and application scenarios thereof.

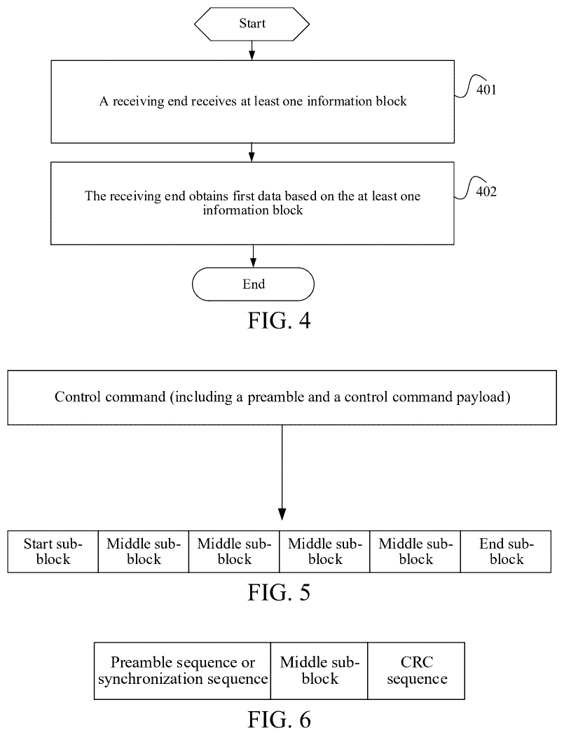

As shown in FIG. 4, an embodiment of this application provides an information transmission method, including the following steps.

Step 401: A receiving end receives at least one information block.

Step 402: The receiving end obtains first data based on the at least one information block.

The first data includes at least one of the following: a wake-up signal and information of backscatter communication.

It should be noted that the at least one information block may be understood as that the receiving end receives only one information block or the receiving end receives at least two information blocks.

It should be noted that the backscatter communication information may include a control command for the backscatter communication and/or a tag reflection signal for the backscatter communication.

For example, the control command may include instructions shown in Table 1.

TABLE 1
Comparison table of control commands and function description

| Operation types | Instructions | Functions |
|---|---|---|
| Selection operation | Select | Select a tag. Allow an interrogator to select |
| | | tag filling for subsequent inventory |
| | Challenge | Allow an interrogator to challenge tag filling |
| | | for subsequent identity authentication |
| Inventory | Query | Start an inventory action. |
| operation | | Start a process of inventory, and determine |
| | | tags that participate in the process of |
| | | inventory. |
| | | Include a slot count parameter Q. When a |
| | | query participation tag is received, a random |
| | | value in a range (0, 2Q − 1) is selected, and |
| | | load the value to a slot counter. Select a tag |
| | | that transitions from zero to a reply state and |
| | | immediately makes a reply Select a tag that |
| | | transitions from a non-zero value to an |
| | | arbitration state and waits for a QueryAdjust |
| | | or QueryRep command |
| | Query adjust | Adjust a quantity of original slots of a tag |
| | Query repeat | Reduce the number of slots of a tag |
| | EPC acknowledgment | Instruction responded to a tag by a reader. |
| | (ACK) | The tag is backscattered to an RN 16. |
| | Non-acknowledgment | Instruction sent by a reader |
| | (NAK) | A tag returns to an arbitrate state |
| | | At any time, an interrogator may send NAK |
| | | as a response, and all tags in this process of |
| | | inventory that receive the NAK return to the |
| | | arbitrate state without changing their |
| | | inventory flags |
| Access | Random request | Require a tag to generate a random number |
| | (Req_RN) | |
| | Read | Read data from a position in storage of a tag |
| | Write | Write data into storage of a tag |
| | Kill | No response is made to any reader anymore |
| | | Prevent leakage of privacy |
| | | A tag cannot be used anymore |
| | Lock | A writing action can no longer be performed |
| | | on a tag |
| | | Prevent data from being arbitrarily changed |
| | Access (optional) | Switch a tag from an open state to a secure |
| | | state when the tag has a password |
| | Block write | Write into a plurality of blocks at a time |
| | (BlockWrite) (optional) | |
| | Block Erase | Clear a plurality of blocks in storage of a |
| | (BlockErase) (optional) | single tag |
| | Authenticate, | Security-related access command |
| | secure communication | The authenticate command may implement a |
| | (SecureComm), | tag, an interrogator, and/or mutual |
| | AuthComm, | authentication, depending on implementation |
| | key update (KeyUpdate), | of a cipher suite specified by a CSI in the |
| | and | command by the tag. |
| | tag privilege | The AuthComm command allows |
| | (TagPrivilege) | authenticated R-to-T communication. |
| | | The SecureComm command allows secure |
| | | R-to-T communication. |
| | | The KeyUpdate command allows an |
| | | authenticated interrogator to write or change |
| | | a key. |
| | | The TagPrivilege command allows the |
| | | interrogator to read or modify a privilege to |
| | | access a password or a key. |
| | File open (FileOpen), | Access-related command for file |
| | file list (FileList), | management. |
| | file privilege | File management access commands include |
| | (FilePrivilege), and | FileOpen, FileList, FileSetup, and |
| | file setup (FileSetup) | FilePrivilege. |
| | | The FileOpen command allows an |
| | | interrogator to open a file. |
| | | The FileList command allows the |
| | | interrogator to determine presence, sizes, |
| | | attributes, and privileges of one or more |
| | | files. |
| | | The FileSetup command allows the |
| | | interrogator to change a file type of a |
| | | currently opened file and/or adjust a size of |
| | | the currently opened file. |
| | | The FilePrivilege command allows the |
| | | interrogator to read or change a privilege |
| | | (see below) granted to the currently opened |
| | | file to an open state, and access a password |
| | | or a key. |
| | Req_RN, | Core access commands. |
| | Read, | The core access commands include Req_RN, |
| | Write, | Read, Write, Lock, Kill, Access, BlockWrite, |
| | Lock, | BlockErase, BlockPermalock, and |
| | Kill, | Untraceable. Req_RN, Read, Write, Lock, |
| | Access, | and Kill are necessary. Access, BlockWrite, |
| | Block Write, and | BlockErase, BlockPermalock, and |
| | BlockErase. | Untraceable are optional. A tag may |
| | The foregoing several | implement one or more optional commands, |
| | commands have been | regardless of whether the tag supports |
| | listed separately in the | encryption security or file management. |
| | foregoing table. | The Write, BlockWrite, and BlockErase |
| | BlockPermalock, and | commands allow the interrogator to write or |
| | untraceable | erase part of storage of a tag. |
| | | The Lock and BlockPermalock commands |
| | | allow the interrogator to configure part of the |
| | | storage of the tag to be changeable, |
| | | permanently writable, or non-writable. |
| | | The Untraceable command allows an |
| | | interrogator with an asserted untraceable |
| | | permission. |

For example, in this embodiment of this application, the at least one information block is sent by a sending end. The sending end needs to first split first data to be sent into at least one sub-block, and then sends the at least one information block to the receiving end based on the at least one sub-block. Generally, each sub-block needs to correspond to one information block.

That is, the sending end needs to split the first data into one or more sub-blocks, and then assemble the sub-blocks to finally form at least one information block, and then sends the information block.

For example, the sending end splits the first data to be sent into at least one sub-block based on fourth information.

The fourth information includes at least one of the following.

A11: Quantity information of the sub-blocks into which the first data is split.

A12: Bit length of the sub-block.

It should be noted that only one of A11 and A12 may exist, that is, a total quantity of sub-blocks into which the first data needs to be split may be determined based on a quantity or a length.

A13: Division manner of the first data.

In at least one embodiment of this application, the splitting method of the first data includes at least one of the following.

A131: Perform bit splitting on the first data, where each sub-block carries some bits of the first data.

In this case, the sending end may sequentially perform bit splitting based on a bit composition sequence of the first data, to obtain a plurality of sub-blocks, where each sub-block includes some bits. For example, the first data includes a total of 100 bits, the first data is split into a total of five sub-blocks based on 20 bits as a group, and each sub-block carries 20 bits.

It should be noted that, in this splitting method, information carried by each sub-block is incomplete. Therefore, during reception, the receiving end decodes some accessory information (for example, code, a monitoring time window, and a start/middle/end sequence) other than the sub-block in each information block. Then, after all the information blocks are received, a sub-block part of each information block is extracted for joint decoding, to obtain the complete first data.

A132: Perform sub-data splitting on the first data, where each sub-block carries sub-data of the first data, and the sub-data is sub-indication information of indication information carried by the first data.

In this case, the sending end may split the indication information into the sub-indication information based on the indication information carried by the first data. For example, the first data carries indication A, and the indication A includes sub-indication A1, sub-indication A2, and sub-indication A3. In this case, after the first data is split, three sub-blocks are obtained, and the three sub-blocks respectively carry the sub-indication A1, the sub-indication A2, and the sub-indication A3.

It should be noted that, in this splitting method, because each sub-block is equivalent to one piece of complete indication information, after receiving one information block, the receiving end may independently perform decoding to obtain corresponding sub-indication information without a need to wait until all information blocks have been received before decoding control information.

For example, as shown in FIG. 5, the sending end splits a control command (including a preamble and a control command payload) for the backscatter communication into six sub-blocks, including a first sub-block (which may be referred to as a start sub-block) arranged at a first position, a last sub-block (which may be referred to as an end sub-block) arranged at a last position, and sub-blocks (which may be referred to as middle sub-blocks) arranged between the first sub-block and the last sub-block. According to the splitting method of A131, it is only necessary to correspondingly perform bit splitting on the control command from front to back. According to the splitting method of A132, the sending end needs to set a splitting rule, and then splits the control command into a plurality of subcommands. During combination, the receiving end may combine the subcommands according to a combination rule corresponding to the splitting rule.

For example, corresponding to the foregoing splitting method, the information block corresponding to the sub-block satisfies one of the following.

A21: The information block carries some bits of the first data.

It should be noted that, this case corresponds to the splitting method of A131.

A22: The information block carries the sub-data of the first data, where the sub-data is the sub-indication information of the indication information carried by the first data.

It should be noted that, this case corresponds to the splitting method of A132.

For example, a length of each information block of the at least one information block should be less than or equal to a first preset bit length. In other words, the first preset bit length is a maximum bit length of the information block. For example, the first preset bit length may be configured, preconfigured, or agreed upon in a protocol. For example, in a case that the length of each information block satisfies the foregoing requirement, lengths of every two information blocks may be the same or different.

For example, the at least one information block satisfies at least one of the following.

A31: Bit length of each information block of the at least one information block is the same.

It should be noted that, to reduce complexity of decoding the information block by the receiving end, the bit length of each information block of the at least one information block should be equal. For example, the bit length of each information block may be equalized in a manner of adding a redundancy bit or a truncation bit, or the like. This is not specifically limited herein.

A33: Time interval between adjacent information blocks of the at least one information block is less than or equal to a first time interval.

For example, the time interval value is a transmission time interval.

It should be further noted that, to ensure that transmission of the first data is within an allowed delay range, a quantity of the at least one information block should be less than or equal to a preset quantity. For example, the preset quantity may be configured, preconfigured, or agreed upon in a protocol.

For example, a specific implementation in which the sending end sends at least one information block to the receiving end based on the at least one sub-block includes: The sending end obtains at least one information block based on the at least one sub-block and first information, and then sends the at least one information block to the receiving end. In this case, that is, some or all of the at least one information block carry the first information. It should be noted that first information carried by different information blocks may be the same or different.

For example, the first information includes at least one of the following parameters.

A31: Index information of a target information block.

It should be noted that the target information block is any one of the information blocks carrying the first information.

A32: Type information of the target information block.

For example, a type of the target information block indicated by the type information of the target information block includes at least one of the following:

A331: a start information block, where the start information block is an earliest information block of the at least one information block;

A332: an end information block, where the end information block is a latest information block of the at least one information block; and

A333: a middle information block, where the middle information block is an information block between the earliest information block and the latest information block of the at least one information block.

A34: Data part length information of the target information block.

A35: Total quantity of information blocks associated with the first data.

A36: Monitoring time window information of the at least one information block.

For example, the monitoring time window information includes at least one of the following:
a monitoring start position, a monitoring end position, and monitoring duration.

For example, the monitoring start position is an end position or a start position of a start information block of the at least one information block.

It should be noted herein that parameters of first information carried by different information blocks may be the same or different. In addition, values of the parameters carried by the different information blocks may be the same or different.

For example, in a case that the first information includes the monitoring time window information of the at least one information block, the sending end completes sending of the at least one information block within a monitoring time window. Further, the receiving end completes reception of the at least one information block within the monitoring time window.

It should be noted that, if the monitoring start position is the end position of the start information block of the at least one information block, another information block other than the start information block of the at least one information block is transmitted within the monitoring time window; or if the monitoring start position is the start position of the start information block of the at least one information block, all of the at least one information block are transmitted within the monitoring time window.

For example, the start information block of the at least one information block carries second information, and the second information includes at least one of the following parameters:

A41: index information of the start information block;

A42: data part length information of the start information block;

A43: a total quantity of information blocks associated with the first data; and

A44: monitoring time window information of the at least one information block.

It may be understood that the second information is a subset of the first information.

For example, the middle information block or the end information block of the at least one information block carries third information, and the third information includes at least one of the following parameters:

A51: index information of a first information block; and

A52: data part length information of the first information block.

It may be understood that the third information is a subset of the first information.

Specific application of the first information is described below through examples.

Application case 1: The second information corresponding to the start information block includes: the index information of the start information block and the total quantity of information blocks associated with the first data; the third information corresponding to the middle information block includes: index information of the middle information block; and the third information corresponding to the end information block includes: index information of the end information block.

For example, in this case, each information block may further include: data part length information of the information block.

Application case 2: The second information corresponding to the start information block includes: the monitoring time window information of the at least one information block.

For example, in this case, each information block may further include: data part length information of the information block.

It should be further noted that, in some embodiments, the first information is carried by a first sequence in the target information block.

For example, the first sequence satisfies at least one of the following:

B11: being used for time-frequency domain synchronization or timing; and

B12: being used to perform decoding or information verification of the at least one information block.

It should be noted that, in a case, if the target information block is the start information block, and the first sequence carries the monitoring time window information of the at least one information block, the first sequence in the start information block is used to perform decoding or information verification of another information block other than the start information block of the at least one information block.

For example, the first sequence includes at least one of the following.

B21: Preamble sequence.

It should be noted that the preamble sequence is usually located at a header of the target information block.

B22: Synchronization sequence.

It should be noted that the synchronization sequence is usually located at the header of the target information block.

B23: Cyclic redundancy check (CRC) sequence.

It should be noted that the CRC sequence is usually located at a tail of the target information block, that is, when assembling the CRC sequence with a sub-block, the sending end needs to place the CRC sequence immediately after a last bit of all bits included in the sub-block.

For example, in a case that the first information includes the type information of the target information block, the first sequence is associated with the type of the target information block. An understanding manner is that different compositions (for example, bit sorting) of the first sequence may represent different types of information blocks. Such a manner may be understood as implicitly indicating a type of an information block through the first sequence. Another understanding manner is that the first sequence includes a bit indicating a type of an information block. Such a manner may be understood as explicitly indicating a type of an information block through the first sequence.

For example, the first sequence in the start information block may be referred to as a start sequence, the first sequence in the end information block may be referred to as an end sequence, and the first sequence in the middle information block may be referred to as a middle sequence.

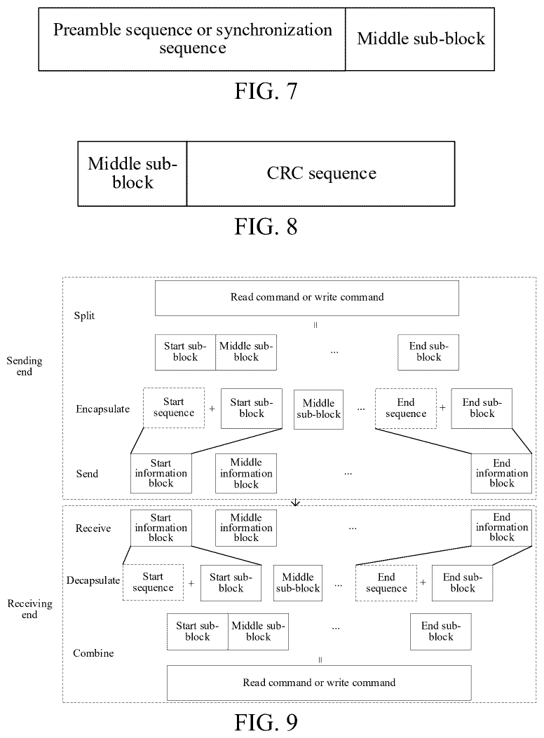

For example, distribution positions of the preamble sequence, the synchronization sequence, and the CRC sequence in the middle information block are shown in FIG. 6 to FIG. 8.

For example, to ensure that the receiving end can smoothly receive the at least one information block, the sending end further needs to first send first configuration information to the receiving end before sending the at least one information block, so that the receiving end can receive the first configuration information, and receive the at least one information block based on the first configuration information.

For example, the first configuration information is used for the receiving end to receive the at least one information block.

The first configuration information includes at least one of the following:

C11: information of a first sequence included in some or all of the at least one information block;
it should be noted that the information of the first sequence may include: a composition manner, a bit arrangement, a type, or the like of the first sequence, which is not limited herein;

C12: a splitting method of the first data;

C13: a bit length of each information block of the at least one information block;

C14: a type of each information block of the at least one information block;

C15: monitoring time window information of the at least one information block;

C16: a total quantity of information blocks associated with the first data;

C17: index information of some or all of the at least one information block; and

C18: a first operation performed by the receiving end based on a reception situation of the at least one information block.

For example, the reception situation includes: the at least one information block is unsuccessfully received (none of some or all of the information blocks is successfully received, which may be understood as that the at least one information block fails to be received (for example, not being received or being decoded in error)); or the at least one information block is successfully received, which may be understood as that some or all of the at least one information block are successfully received.

For example, after receiving the at least one information block, the receiving end may further perform a first operation based on the reception situation of the at least one information block.

The first operation includes at least one of the following.

C21: Perform a second operation in a case that the reception situation of the at least one information block is that the at least one information block is unsuccessfully received.

For example, the second operation includes at least one of the following:

C211: ignoring indication information of a received information block;

C212: discarding the received information block; and

C213: performing no joint decoding on the received information block.

C22: Send first feedback information, where the first feedback information indicates a reception status of the at least one information block and/or index information of an incorrectly received information block.

For example, if the first data is the control command for the backscatter communication, the first feedback information is sent in a form of backscatter.

The reception status includes at least one of the following:

C221: the at least one information block is successfully received or fails to be received, which may be understood as that some or all of the at least one information block are successfully received or fail to be received; and

C222: a cause of a reception failure of the at least one information block, which may be understood as a cause of a reception failure of an information block that fails to be received of the at least one information block.

For example, the cause of the reception failure includes, but is not limited to, at least one of the following: being decoded in error, not being received, and the like.

For example, the at least one information block satisfies at least one of the following.

C31: Each information block of the at least one information block carries some bits of the first data and at least some parameters of the first information.

It should be noted that, in this case, each information block needs to carry the bit of the first data and the parameter of the first information.

For example, the sending end splits the first data according to the splitting method of A131, to obtain five sub-blocks, and each sub-block of the five sub-blocks includes some bits of the first data. When information blocks are obtained from the sub-blocks, the parameter of the first information needs to be assembled in each information block, to obtain final five information blocks.

C32: A first type of information block of the at least one information block carries some bits of the first data, and a second type of information block carries at least some parameters of the first information.

Each of the first type of information block and the second type of information block includes at least one information block, and the first type of information block is different from the second type of information block.

It should be noted that, in this case, the information block carrying the bit of the first data and the information block carrying the parameter of the first information are split, and are used separately.

For example, the sending end splits the first data according to the splitting method of A131, to obtain five sub-blocks, and each sub-block of the five sub-blocks includes some bits of the first data. When information blocks are obtained from the sub-blocks, five information blocks are directly obtained from the five sub-blocks, and then one or two or more information blocks are determined based on the parameter of the first information. For example, if one information block is determined based on the parameter of the first information, the sending end finally needs to transmit six information blocks.

C33: A third type of information block of the at least one information block carries some bits of the first data and at least some parameters of the first information, and a fourth type of information block carries at least some parameters of the first information.

Each of the third type of information block and the fourth type of information block includes at least one information block, and the third type of information block is different from the fourth type of information block.

It should be noted that, in this case, the information block carrying the bit of the first data and the information block carrying the parameter of the first information partially overlap.

For example, the sending end splits the first data according to the splitting method of A131, to obtain five sub-blocks, and each sub-block of the five sub-blocks includes some bits of the first data. When information blocks are obtained from the sub-blocks, each sub-block is assembled with the parameter of the first information, to obtain five information blocks, and then one or two or more information blocks are determined based on the parameter of the first information. For example, if one information block is determined based on the parameter of the first information, the sending end finally needs to transmit six information blocks.

C34: A fifth type of information block of the at least one information block carries some bits of the first data and at least some parameters of the first information, and a sixth type of information block carries some bits of the first data.

Each of the fifth type of information block and the sixth type of information block includes at least one information block, and the fifth type of information block is different from the sixth type of information block.

It should be noted that, in this case, the information block carrying the bit of the first data and the information block carrying the parameter of the first information partially overlap.

For example, the sending end splits the first data according to the splitting method of A131, to obtain five sub-blocks, and each sub-block of the five sub-blocks includes some bits of the first data. When information blocks are obtained from the sub-blocks, only one of the five sub-blocks is assembled with the parameter of the first information, to obtain five information blocks. In this case, the sending end finally needs to transmit five information blocks.

For example, after receiving the at least one information block, the receiving end may obtain the first data based on the at least one information block.

Further, an implementation in which the receiving end obtains the first data based on the at least one information block includes at least one of the following.

D11: The receiving end performs, based on target bits of the at least one information block, concatenation on the target bits to obtain the first data.

It should be noted that, this case corresponds to the splitting method of A131. In the splitting method of A131, after receiving all the information blocks, the receiving end extracts a sub-block part of each information block for joint decoding, to obtain the complete first data.

D12: The receiving end obtains indication information carried by the first data based on target indication information of the at least one information block and a combination rule of the target indication information.

It should be noted that this case corresponds to the splitting method of A132. In the splitting method of A132, after receiving one information block, the receiving end performs decoding to obtain corresponding sub-indication information. After all sub-indication information is obtained, the final first data can be determined and obtained based on the combination rule (in some embodiments, the combination rule may include an OR operation, an AND operation, and the like on the sub-indication information) that corresponds to a splitting rule of the first data.

It should be further noted that the sending end in embodiments of this application may be a network side device. For example, the network side device is an access network device, and a type of the access network device includes, but is not limited to: an Integrated Access and Backhaul (IAB) node (IAB node); a repeater, for example, a network controlled repeater; a pole station, and the like.

The receiving end may be a backscatter device in the backscatter communication, for example, a tag, or may be a terminal device.

For example, in a case that the first data is the wake-up signal, the sending end is the network side device, and the receiving end is the terminal device. For example, in a case that the first data is the control command for the backscatter communication, the sending end is the network side device, and the receiving end is the tag. In some embodiments, the sending end is the terminal device, and the receiving end is the tag. For example, in a case that the first data is the tag reflection signal for the backscatter communication, the sending end is the tag, and the receiving end is the terminal device. In some embodiments, the sending end is the tag, and the receiving end is the network side device.

An example in which the first data is the control command for the backscatter communication is used to describe specific application of this application below.

In an application instance 1, a monitoring start and a monitoring end of an information block included in a control command for backscatter communication are represented by using a start sequence and an end sequence.

### Sending End Side

A backscatter command, for example, a read command or write command, is split according to a specific splitting rule. Information carried by the read command or write command includes 100 bits. The splitting rule is splitting the 100 bits into 5 sub-blocks, each with a length of 20 bits. If a first sub-block of the five sub-blocks is a start sub-block, and a last sub-block is an end sub-block, remaining sub-blocks are middle sub-blocks.

### Encapsulating Different Types of Sub-Blocks According to a Preset Rule

For the start sub-block, a start sequence is added, where the start sequence is a first preamble sequence. In addition, the first preamble sequence can indicate that a type of the start sub-block is the start sub-block.

For example, for the middle sub-block, a middle sequence may or may not be added (FIG. 9 is based on a case where no middle sequence is added to the middle sub-block), where the middle sequence is a second preamble sequence. In addition, the second preamble sequence can indicate that a type of the start sub-block is the middle sub-block.

For the end sub-block, an end sequence is added, where the end sequence is a third preamble sequence. In addition, the third preamble sequence can indicate that a type of the start sub-block is the end sub-block.

It should be noted that the start sequence, the middle sequence, and the end sequence are different sequences, and an information block is formed after the sub-blocks are encapsulated.

### Receiving End Side

Five information blocks associated with the read command or write command are received; and then, sub-block bits of the five information blocks are extracted and recombined into a control information payload part of a complete read command or write command.

After splitting, because there is a need to avoid a situation where continuous transmission cannot be implemented in a TDD framework due to an excessive length of each information block, a size of each information block needs to be limited to a specific size, where the specific size is configured by a network or agreed upon in a protocol. In addition, the start sequence and the end sequence added to the start sub-block and the end sub-block are also configured by a network or agreed upon in a protocol.

For example, a process in which the sending end and the receiving end implement transmission of the control command for the backscatter communication is shown in FIG. 9.

In an application instance 2, a start information block and an end information block of an information block associated with a control command for backscatter communication are determined by using an index (for example, a number of an information block), where the start information block carries a total quantity of information blocks associated with the control command.

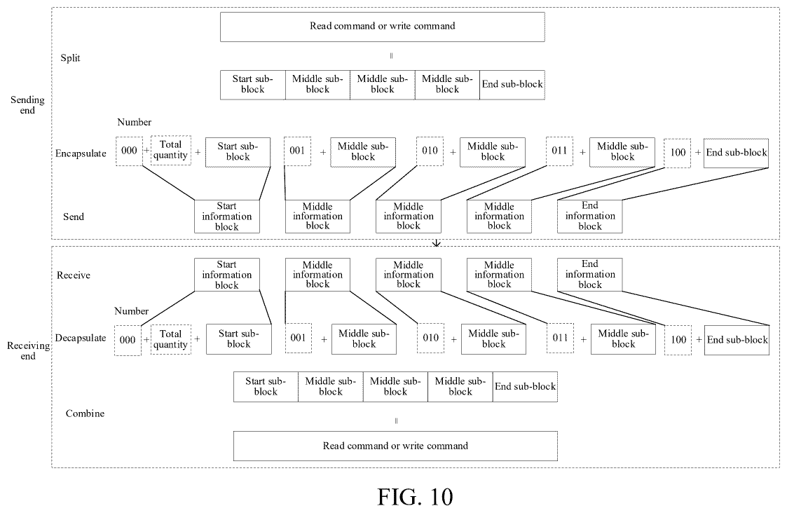

When the sending end performs encapsulation, corresponding number information may further be added for different sub-blocks. For example, a network configures two or three bits specially used to carry a number corresponding to each sub-block or information block, which may be a similar process to the foregoing process of configuring the start sequence and the end sequence. Details are shown in FIG. 10. It should be emphasized that, because the number cannot determine an information block that is the end information block, the information block may be determined based on the total quantity of information blocks carried by the start information block.

In an application instance 3, a start information block and an end information block of an information block associated with a control command for backscatter communication are determined by using a monitoring time window.

From the perspective of the sending end, monitoring time window information is added when a start sub-block is encapsulated, to indicate a time domain monitoring range of subsequent sub-blocks (which may be understood as including the start sub-block). In this application, because the start information block may carry the monitoring time window information, and transmission of some subsequent information blocks may be completed within the monitoring time window, there may be no need to add information of a sequence or a number similar to that provided in the application instance 1 and the application instance 2 to the subsequent information blocks. For transmission reliability, a possibility of using the monitoring time window in combination with a sequence or a number is not excluded in this application instance.

From the perspective of the receiving end, after the start information block is received, the monitoring time window information may be obtained based on decoding of the start information block, for subsequent reception of remaining information blocks. After all information blocks are received, a corresponding control command may be obtained.

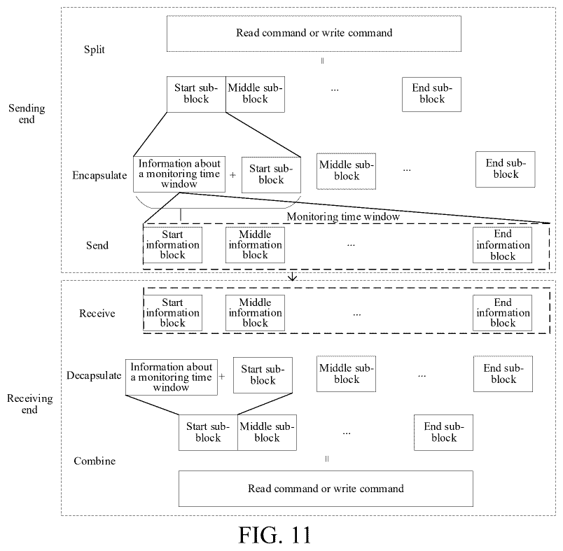

For example, a process in which the sending end and the receiving end implement transmission of the control command for the backscatter communication is shown in FIG. 11. In FIG. 11, a middle sub-block directly generates a middle information block without a need to be assembled with other information.

In an application instance 4, a start and an end of an information block associated with a control command for backscatter communication are determined by using any two of a monitoring time window, a start sequence, a middle sequence, an end sequence, and a number.

It should be noted that this application instance is a combination of any two of the foregoing application instance 1 to application instance 3. For specific application, refer to the foregoing instances. Details are not described herein again.

It should be noted that in at least one embodiment of this application, the backscatter communication and discontinuous transmission of the wake-up signal in a TDD scenario are implemented.

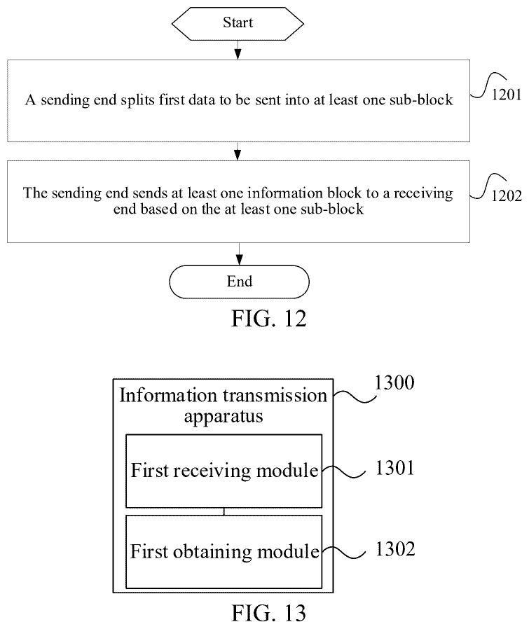

As shown in FIG. 12, an embodiment of this application provides an information transmission method, including the following steps.

Step 1201: A sending end splits first data to be sent into at least one sub-block.

Step 1202: The sending end sends at least one information block to a receiving end based on the at least one sub-block, where the at least one information block is used for the receiving end to obtain the first data.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, that the sending end splits the first data to be sent into the at least one sub-block includes:

The sending end splits the first data to be sent into at least one sub-block based on fourth information.

The fourth information includes at least one of the following:
quantity information of the sub-blocks into which the first data is split;
a bit length of the sub-block; and
a splitting method of the first data.

For example, that the sending end sends the at least one information block to the receiving end based on the at least one sub-block includes:

The sending end obtains at least one information block based on the at least one sub-block and first information; and
the sending end sends the at least one information block to the receiving end.

The first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, that the sending end sends the at least one information block to the receiving end includes:

The sending end completes sending of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, before the sending end sends the at least one information block to the receiving end, the method further includes:
sending first configuration information to the receiving end, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the splitting method of the first data includes at least one of the following:
performing bit splitting on the first data, where each sub-block carries some bits of the first data; and
performing sub-data splitting on the first data, where each sub-block carries sub-data of the first data, and the sub-data is sub-indication information of indication information carried by the first data.

It should be noted that all descriptions about the sending end in the foregoing embodiments are applicable to embodiments of the information transmission method applied to the sending end, and a same technical effect can also be achieved. Details are not described herein again.

The information transmission method provided in embodiments of this application may be executed by an information transmission apparatus. In embodiments of this application, an example in which the information transmission apparatus executes the information transmission method is used to describe the information transmission apparatus provided in embodiments of this application.

As shown in FIG. 13, an information transmission apparatus 1300 according to an embodiment of this application is used in a receiving end, and includes:
a first receiving module 1301, configured to receive at least one information block; and
a first obtaining module 1302, configured to obtain first data based on the at least one information block.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, some or all of the at least one information block carry first information, and the first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, the first receiving module 1301 is configured to:
complete reception of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one-to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, the information transmission apparatus 1300 further includes:
a second receiving module, configured to receive first configuration information, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the first obtaining module 1302 is configured to:
perform, based on target bits of the at least one information block, concatenation on the target bits to obtain the first data; or
obtain indication information carried by the first data based on target indication information of the at least one information block and a combination rule of the target indication information.

For example, the information transmission apparatus 1300 further includes:
an execution module, configured to perform the first operation based on the reception situation of the at least one information block.

The first operation includes at least one of the following:
performing a second operation in a case that the reception situation of the at least one information block is that the at least one information block is unsuccessfully received; and
sending first feedback information, where the first feedback information indicates a reception status of the at least one information block and/or index information of an incorrectly received information block.

The reception status includes at least one of the following:
the at least one information block is successfully received or fails to be received; and
a cause of a reception failure of the at least one information block.

The second operation includes at least one of the following:
ignoring indication information of a received information block;
discarding the received information block; and
performing no joint decoding on the received information block.

It should be noted that the apparatus embodiment corresponds to the foregoing method embodiment, all implementations in the foregoing method embodiment are applicable to the apparatus embodiment, and a same technical effect can also be achieved.

The information transmission apparatus in embodiments of this application may be an electronic device, for example, an electronic device having an operating system, or a component in an electronic device, for example, an integrated circuit or a chip. The electronic device may be a terminal, or may be another device other than a terminal. For example, the terminal may include, but is not limited to, types of the terminal 11 listed above. The another device may be a server, a Network Attached Storage (NAS), or the like. This is not specifically limited in embodiments of this application.

The information transmission apparatus provided in embodiments of this application can implement each process implemented in the method embodiment in FIG. 4, and achieves a same technical effect. To avoid repetition, details are not described herein again.

An embodiment of this application further provides a receiving end, including a processor and a communication interface. The communication interface is configured to receive at least one information block. The processor is configured to obtain first data based on the at least one information block.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, some or all of the at least one information block carry first information, and the first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, the communication interface is configured to:
complete reception of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one-to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, the communication interface is further configured to:
receive first configuration information, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the processor is configured to:
perform, based on target bits of the at least one information block, concatenation on the target bits to obtain the first data; or
obtain indication information carried by the first data based on target indication information of the at least one information block and a combination rule of the target indication information.

For example, the processor is further configured to
perform the first operation based on the reception situation of the at least one information block.

The first operation includes at least one of the following:
performing a second operation in a case that the reception situation of the at least one information block is that the at least one information block is unsuccessfully received; and
sending first feedback information, where the first feedback information indicates a reception status of the at least one information block and/or index information of an incorrectly received information block.

The reception status includes at least one of the following:
the at least one information block is successfully received or fails to be received; and
a cause of a reception failure of the at least one information block.

The second operation includes at least one of the following:
ignoring indication information of a received information block;
discarding the received information block; and
performing no joint decoding on the received information block.

The receiving end embodiment corresponds to the foregoing method embodiment of the receiving end side. All implementation processes and implementations in the foregoing method embodiment of the receiving end side are applicable to the receiving end embodiment, and a same technical effect can be achieved.

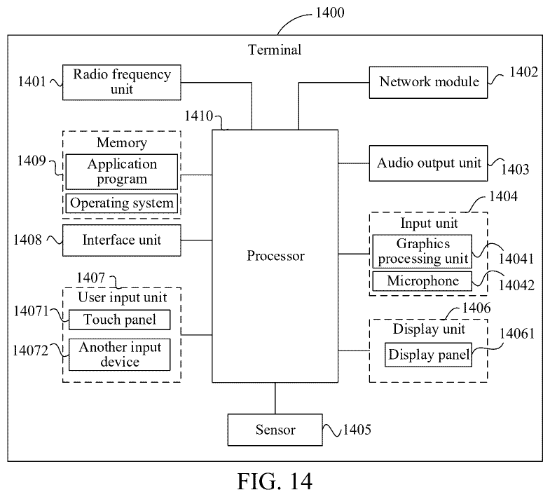

For example, the receiving end may be a terminal. For example, FIG. 14 is a diagram of a hardware structure of a terminal implementing an embodiment of this application.

The terminal 1400 includes, but is not limited to: at least some of components such as a radio frequency unit 1401, a network module 1402, an audio output unit 1403, an input unit 1404, a sensor 1405, a display unit 1406, a user input unit 1407, an interface unit 1408, a memory 1409, and a processor 1410.

Those skilled in the art can understand that the terminal 1400 may further include a power supply (such as a battery) for supplying power to all the components. The power supply may be logically connected to the processor 1410 through a power management system, to implement functions such as charging management, discharging management, and power consumption management through the power management system. The terminal structure shown in FIG. 14 does not impose a limitation on the terminal. The terminal may include more or fewer components than those shown in the figure, or combine some components, or adopt different component arrangements. Details are not described herein again.

It should be understood that, in embodiments of this application, the input unit 1404 may include a Graphics Processing Unit (GPU) 14041 and a microphone 14042. The graphics processing unit 14041 processes image data of a static picture or a video that is obtained by an image capture apparatus (for example, a camera) in a video capture mode or an image capture mode. The display unit 1406 may include a display panel 14061, which may be configured in a form of a liquid crystal display, an organic light-emitting diode, or the like. The user input unit 1407 includes a touch panel 14071 and at least one of other input devices 14072. The touch panel 14071 is also referred to as a touchscreen. The touch panel 14071 may include two parts: a touch detection apparatus and a touch controller. The other input devices 14072 may include, but are not limited to, a physical keyboard, a functional key (such as a volume control key or a switch key), a track ball, a mouse, and a joystick. Details are not described herein again.

In this embodiment of this application, after receiving downlink data from a network side device, the radio frequency unit 1401 may transmit the downlink data to the processor 1410 for processing. In addition, the radio frequency unit 1401 may send uplink data to the network side device. Generally, the radio frequency unit 1401 includes, but is not limited to, an antenna, an amplifier, a transceiver, a coupler, a low noise amplifier, a duplexer, and the like.

The memory 1409 may be configured to store a software program or instructions and various data. The memory 1409 may primarily include a first storage area configured to store the program and instructions, and a second storage area configured to store the data, where the first storage area may store an operating system, an application program or instructions required by at least one function (such as a sound playback function and an image display function), and the like. In addition, the memory 1409 may include a volatile memory or a non-volatile memory, or may include both a volatile memory and a non-volatile memory. The non-transitory memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1409 in this embodiment of this application includes, but is not limited to, these memories and any other suitable types of memories.

The processor 1410 may include one or more processing units. For example, the processor 1410 integrates an application processor and a modem processor, where the application processor mainly processes operations relating to an operating system, a user interface, an application program, and the like, and the modem processor, such as a baseband processor, mainly processes a wireless communication signal. In some embodiments, it may be understood that the modem processor may not be integrated into the processor 1410.

The radio frequency unit 1401 is configured for
a receiving end to receive at least one information block.

The processor 1410 is configured to:
obtain first data based on the at least one information block.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, some or all of the at least one information block carry first information, and the first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, the radio frequency unit 1401 is configured to:
complete reception of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one-to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, the radio frequency unit 1401 is further configured to
receive first configuration information, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the processor 1410 is configured to:
perform, based on target bits of the at least one information block, concatenation on the target bits to obtain the first data; or
obtain indication information carried by the first data based on target indication information of the at least one information block and a combination rule of the target indication information.

For example, the processor 1410 is further configured to
perform the first operation based on the reception situation of the at least one information block.

The first operation includes at least one of the following:
performing a second operation in a case that the reception situation of the at least one information block is that the at least one information block is unsuccessfully received; and
sending first feedback information, where the first feedback information indicates a reception status of the at least one information block and/or index information of an incorrectly received information block.

The reception status includes at least one of the following:
the at least one information block is successfully received or fails to be received; and
a cause of a reception failure of the at least one information block.

The second operation includes at least one of the following:
ignoring indication information of a received information block;
discarding the received information block; and
performing no joint decoding on the received information block.

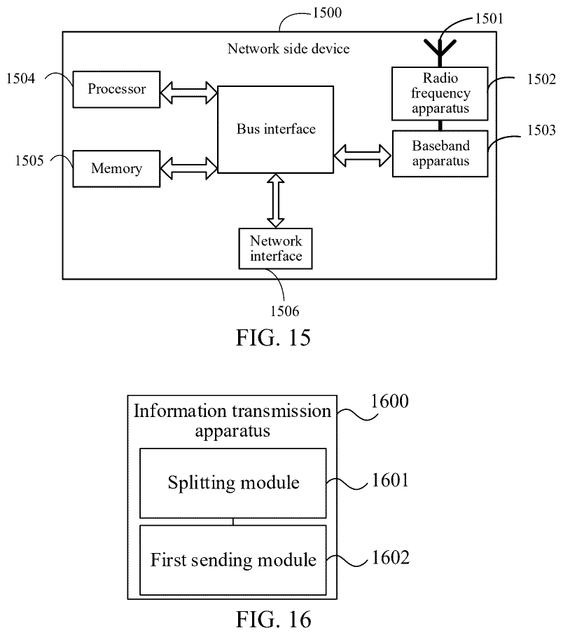

For example, the receiving end may be a network side device. FIG. 15 is a diagram of a structure of a network side device according to an embodiment of this application. The network side device 1500 includes: an antenna 1501, a radio frequency apparatus 1502, a baseband apparatus 1503, a processor 1504, and a memory 1505. The antenna 1501 is connected to the radio frequency apparatus 1502. In an uplink direction, the radio frequency apparatus 1502 receives information by using the antenna 1501, and sends the received information to the baseband apparatus 1503 for processing. In a downlink direction, the baseband apparatus 1503 processes information to be sent and send the information to the radio frequency apparatus 1502. The radio frequency apparatus 1502 processes received information and sends the information through the antenna 1501.

In the foregoing embodiment, the method performed by the network side device may be implemented in the baseband apparatus 1503. The baseband apparatus 1503 includes a baseband processor.

The baseband apparatus 1503 may include, for example, at least one baseband board. A plurality of chips are arranged on the baseband board. As shown in FIG. 15, a chip is, for example, a baseband processor, and is connected to the memory 1505 through a bus interface to invoke a program in the memory 1505 to perform operations of a network device shown in the foregoing method embodiments.

The network side device may further include a network interface 1506. The interface is, for example, a Common Public Radio Interface (CPRI).

For example, the network side device 1500 according to an embodiment of this application further includes: instructions or a program that is stored in the memory 1505 and may be run on the processor 1504. The processor 1504 invokes the instructions or the program in the memory 1505 to perform the method performed by each module shown in FIG. 13, and a same technical effect is achieved. To avoid repetition, details are not described herein again.

For example, an embodiment of this application further provides a receiving end. The receiving end includes a processor, a memory, and a program or instructions that are stored in the memory and may be run on the processor. When the program or the instructions are executed by the processor, each process of the foregoing information transmission method embodiments of the receiving end is implemented, and a same technical effect can be achieved. To avoid repetition, details are not described herein again.

An embodiment of this application further provides a readable storage medium, storing a program or instructions, where when the program or instructions are executed by a processor, each process of the foregoing information transmission method embodiments is implemented, and a same technical effect can be achieved. To avoid repetition, details are not described herein again.

The computer-readable storage medium is, for example, a Read-Only Memory (ROM), a Random Access Memory (RAM), a magnetic disk, or an optical disc.

As shown in FIG. 16, an embodiment of this application further provides an information transmission apparatus 1600, which is used in a sending end and includes:
a splitting module 1601, configured to split first data to be sent into at least one sub-block; and
a first sending module 1602, configured to send at least one information block to a receiving end based on the at least one sub-block, where the at least one information block is used for the receiving end to obtain the first data.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, the splitting module 1601 is configured to:
split the first data to be sent into at least one sub-block based on fourth information.

The fourth information includes at least one of the following:
quantity information of the sub-blocks into which the first data is split;
a bit length of the sub-block; and
a splitting method of the first data.

For example, the first sending module 1602 includes:
an obtaining unit, configured to obtain at least one information block based on the at least one sub-block and first information; and
a sending unit, configured to send the at least one information block to the receiving end.

The first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, the sending unit is configured to:
complete sending of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one-to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, the information transmission apparatus 1600 further includes:
a second sending module, configured to send first configuration information to the receiving end, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the splitting method of the first data includes at least one of the following:
performing bit splitting on the first data, where each sub-block carries some bits of the first data; and
performing sub-data splitting on the first data, where each sub-block carries sub-data of the first data, and the sub-data is sub-indication information of indication information carried by the first data.

It should be noted that the apparatus embodiment corresponds to the foregoing method embodiment of the sending end, all implementations in the foregoing method embodiment are applicable to the apparatus embodiment, and a same technical effect can also be achieved. Details are not described herein again.

An embodiment of this application further provides a sending end, including a processor and a communication interface. The processor is configured to split first data to be sent into at least one sub-block. The communication interface is configured to send at least one information block to a receiving end based on the at least one sub-block, where the at least one information block is used for the receiving end to obtain the first data.

The first data includes at least one of the following: a wake-up signal and information of backscatter communication.

For example, the at least one information block satisfies at least one of the following:
a bit length of each information block of the at least one information block is the same; and
a time interval between adjacent information blocks of the at least one information block is less than or equal to a first time interval.

For example, the bit length of the information block is less than or equal to a first preset bit length.

For example, the processor is configured to:
split the first data to be sent into at least one sub-block based on fourth information.

The fourth information includes at least one of the following:
quantity information of the sub-blocks into which the first data is split;
a bit length of the sub-block; and
a splitting method of the first data.

For example, the communication interface is configured to:
obtain at least one information block based on the at least one sub-block and first information; and
send the at least one information block to the receiving end.

The first information includes at least one of the following parameters:
index information of a target information block;
type information of the target information block;
data part length information of the target information block;
a total quantity of information blocks associated with the first data; and
monitoring time window information of the at least one information block.

Parameters of first information carried by different information blocks may be the same or different, and the target information block is any one of the information blocks carrying the first information.

For example, a type of the target information block indicated by the type information of the target information block includes at least one of the following:
a start information block, where the start information block is an earliest information block of the at least one information block;
an end information block, where the end information block is a latest information block of the at least one information block; and
a middle information block, where the middle information block is an information block between the earliest information block and the latest information block of the at least one information block.

For example, the start information block of the at least one information block carries second information, and the second information includes at least one of the following parameters:
index information of the start information block;
data part length information of the start information block;
a total quantity of information blocks associated with the first data; and
monitoring time window information of the at least one information block.

For example, the middle information block or the end information block of the at least one information block carries third information, and the third information includes at least one of the following parameters:
index information of an information block; and
data part length information of the information block.

For example, the monitoring time window information includes at least one of the following:
a monitoring start position, a monitoring end position, and monitoring duration.

For example, the monitoring start position is an end position or a start position of a start information block of the at least one information block.

For example, in a case that the first information includes the monitoring time window information of the at least one information block, the communication interface is configured to:
complete sending of the at least one information block within the monitoring time window.

For example, the first information is carried by a first sequence in the target information block.

The first sequence satisfies at least one of the following:
being used for time-frequency domain synchronization or timing; and
being used to perform decoding or information verification of the at least one information block.

For example, the first sequence includes at least one of the following:
a preamble sequence;
a synchronization sequence; and
a cyclic redundancy check CRC sequence.

For example, the first sequence and a type of the target information block are one-to-one mapping.

For example, the at least one information block satisfies at least one of the following:
each information block of the at least one information block carries some bits of the first data and at least some parameters of the first information;
a first type of information block of the at least one information block carries some bits of the first data, and a second type of information block carries at least some parameters of the first information;
a third type of information block of the at least one information block carries some bits of the first data and at least some parameters of the first information, and a fourth type of information block carries at least some parameters of the first information; and
a fifth type of information block of the at least one information block carries some bits of the first data and at least some parameters of the first information, and a sixth type of information block carries some bits of the first data.

For example, before the sending end sends the at least one information block to the receiving end, the method further includes:
sending first configuration information to the receiving end, where the first configuration information is used for the receiving end to receive the at least one information block.

The first configuration information includes at least one of the following:
information of a first sequence included in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, and a first operation performed by the receiving end based on a reception situation of the at least one information block.

For example, the splitting method of the first data includes at least one of the following:
performing bit splitting on the first data, where each sub-block carries some bits of the first data; and
performing sub-data splitting on the first data, where each sub-block carries sub-data of the first data, and the sub-data is sub-indication information of indication information carried by the first data.

For example, an embodiment of this application further provides a sending end. The sending end includes a processor, a memory, and a program or instructions that are stored in the memory and may be run on the processor. When the program or the instructions are executed by the processor, each process of the foregoing information transmission method embodiments is implemented, and a same technical effect can be achieved. To avoid repetition, details are not described herein again.

For example, the sending end may be a network side device. For a specific structure, refer to FIG. 14 and FIG. 15. Details are not described herein again.

The sending end in this embodiment of this application includes: instructions or a program that is stored in the memory and may be run on the processor. The processor invokes the instructions or the program in the memory to perform the method performed by each module shown in FIG. 16, and a same technical effect is achieved. To avoid repetition, details are not described herein again.

An embodiment of this application further provides a readable storage medium, storing a program or instructions, where when the program or instructions are executed by a processor, each process of the foregoing information transmission method embodiments is implemented, and a same technical effect can be achieved. To avoid repetition, details are not described herein again.

The processor is the processor in the network side device described in the foregoing embodiments. The readable storage medium includes a computer-readable storage medium, such as a computer read-only memory ROM, a random access memory RAM, a magnetic disk, an optical disc, or the like.

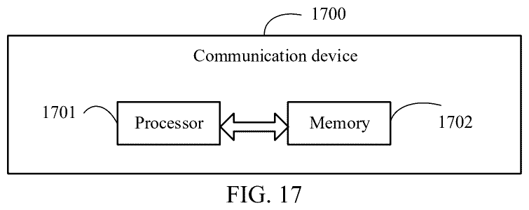

For example, as shown in FIG. 17, an embodiment of this application further provides a communication device 1700, including: a processor 1701 and a memory 1702. The memory 1702 stores a program or instructions that may be run on the processor 1701. For example, in a case that the communication device 1700 is a receiving end, when the program or instructions are executed by the processor 1701, each step of the foregoing information transmission method embodiments of the receiving end is implemented, and a same technical effect can be achieved In a case that the communication device 1700 is a sending end, when the program or instructions are executed by the processor 1701, each step of the foregoing information transmission method embodiments of the sending end is implemented, and a same technical effect can be achieved. To avoid repetition, details are not described herein again.

An embodiment of this application further provides a chip. The chip includes a processor and a communication interface. The communication interface is coupled to the processor. The processor is configured to run a program or instructions to implement each process of the foregoing information transmission method embodiments, and a same technical effect can be achieved. To avoid repetition, details are not described herein again.

It should be understood that the chip mentioned in this embodiment of this application may also be referred to as a system on a chip, a system chip, a chip system, a system-on-chip, or the like.

An embodiment of this application further provides a computer program/program product. The computer program/program product is stored in a storage medium. The computer program/program product is executed by at least one processor to implement each process of the foregoing information transmission method embodiments, and a same technical effect can be achieved. To avoid repetition, details are not described herein again.

An embodiment of this application further provides a communication system, including: a receiving end and a sending end. The receiving end may be configured to perform the steps of the foregoing information transmission method of the receiving end, and the sending end may be configured to perform the steps of the foregoing information transmission method of the sending end.

It should be noted that the terms “include”, “comprise”, or any other variation thereof in this specification are intended to cover a non-exclusive inclusion, so that a process, a method, an article, or an apparatus that includes a list of elements includes those elements, and also includes other elements which are not expressly listed, or further includes elements inherent to this process, method, article, or apparatus. An element preceded by a statement “includes a . . . ” does not, without more constraints, preclude the presence of additional identical elements in the process, method, article, or apparatus that includes the element. In addition, it should be noted that the scopes of the methods and apparatuses in implementations of this application are not limited to performing functions in the order shown or discussed, and may further include performing functions in a substantially simultaneous manner or in a reverse order based on the functions involved. For example, the described methods may be performed in an order different from the described order, and various steps may be further added, omitted, or combined. Moreover, features described with reference to some examples may be combined in other examples.

Based on the foregoing descriptions of the implementations, a person skilled in the art may clearly understand that the method in the foregoing embodiments may be implemented by software in addition to a necessary general hardware platform or by hardware only. In many cases, the former is an example implementation. Based on such an understanding, the technical solutions of this application essentially, or a part contributing to the prior art, may be presented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in embodiments of this application.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make many modifications without departing from the principles of this application and the protection scope of the claims, and all the modifications shall fall within the protection scope of this application.

What is claimed is:

1. An information transmission method, comprising:
receiving, by a receiving end, at least one information block; and
obtaining, by the receiving end, first data based on the at least one information block, wherein
the first data comprises at least one of the following: a wake-up signal or information of backscatter communication.

2. The information transmission method according to claim 1, wherein the at least one information block satisfies at least one of the following:
a bit length of each information block of the at least one information block is the same; or
a time interval between adjacent information blocks of the at least one information block is less than or equal to a first time interval.

3. The information transmission method according to claim 1, wherein the bit length of the information block is less than or equal to a first preset bit length.

4. The information transmission method according to claim 1, wherein some or all of the at least one information block carry first information, and the first information comprises at least one of the following parameters:
index information of a target information block;
type information of the target information block;
data part length information of the target information block;
a total quantity of information blocks associated with the first data; or
monitoring time window information of the at least one information block, wherein
parameters of first information carried by different information blocks is the same or different, and the target information block is any one of the information blocks carrying the first information.

5. The information transmission method according to claim 4, wherein a type of the target information block indicated by the type information of the target information block comprises at least one of the following:
a start information block, wherein the start information block is an earliest information block of the at least one information block;
an end information block, wherein the end information block is a latest information block of the at least one information block; or
a middle information block, wherein the middle information block is an information block between the earliest information block and the latest information block of the at least one information block.

6. The information transmission method according to claim 5, wherein the start information block of the at least one information block carries second information, and the second information comprises at least one of the following parameters:
index information of the start information block;
data part length information of the start information block;
a total quantity of information blocks associated with the first data; or
monitoring time window information of the at least one information block.

7. The information transmission method according to claim 5, wherein the middle information block or the end information block of the at least one information block carries third information, and the third information comprises at least one of the following parameters:
index information of an information block; or
data part length information of the information block.

8. The information transmission method according to claim 4, wherein the monitoring time window information comprises at least one of the following:
a monitoring start position, a monitoring end position, or monitoring duration.

9. The information transmission method according to claim 4, wherein when the first information comprises the monitoring time window information of the at least one information block, the receiving, by the receiving end, the at least one information block comprises:
completing, by the receiving end, reception of the at least one information block within a monitoring time window.

10. The information transmission method according to claim 4, wherein the first information is carried by a first sequence in the target information block, and
the first sequence satisfies at least one of the following:
being used for time-frequency domain synchronization or timing; or
being used to perform decoding or information verification of the at least one information block.

11. The information transmission method according to claim 10, wherein the first sequence comprises at least one of the following:
a preamble sequence;
a synchronization sequence; or
a Cyclic Redundancy Check (CRC) sequence.

12. The information transmission method according to claim 1, wherein before the receiving, by the receiving end, the at least one information block, the method further comprises:
receiving first configuration information, wherein the first configuration information is used for the receiving end to receive the at least one information block, and
the first configuration information comprises at least one of the following:
information of a first sequence comprised in some or all of the at least one information block, a splitting method of the first data, a bit length of each information block of the at least one information block, a type of each information block of the at least one information block, monitoring time window information of the at least one information block, a total quantity of information blocks associated with the first data, index information of some or all of the at least one information block, or a first operation performed by the receiving end based on a reception situation of the at least one information block.

13. An information transmission method, comprising:
splitting, by a sending end, first data to be sent into at least one sub-block; and
sending, by the sending end, at least one information block to a receiving end based on the at least one sub-block, wherein the at least one information block is used for the receiving end to obtain the first data, and
the first data comprises at least one of the following: a wake-up signal or information of backscatter communication.

14. The information transmission method according to claim 13, wherein the at least one information block satisfies at least one of the following:
a bit length of each information block of the at least one information block is the same; or
a time interval between adjacent information blocks of the at least one information block is less than or equal to a first time interval.

15. The information transmission method according to claim 14, wherein the bit length of the information block is less than or equal to a first preset bit length.

16. The information transmission method according to claim 13, wherein the splitting, by the sending end, the first data to be sent into at least one sub-block comprises:
splitting, by the sending end, first data the to be sent into at least one sub-block based on fourth information, wherein
the fourth information comprises at least one of the following:
quantity information of the sub-blocks into which the first data is split;
a bit length of the sub-block; or
a splitting method of the first data.

17. The information transmission method according to claim 13, wherein the sending, by the sending end, the at least one information block to the receiving end based on the at least one sub-block comprises:
obtaining, by the sending end, at least one information block based on the at least one sub-block and first information; and
sending, by the sending end, the at least one information block to the receiving end, wherein
the first information comprises at least one of the following parameters:
index information of a target information block;
type information of the target information block;
data part length information of the target information block;
a total quantity of information blocks associated with the first data; or
monitoring time window information of the at least one information block, wherein
parameters of first information carried by different information blocks is the same or different, and the target information block is any one of the information blocks carrying the first information.

18. The information transmission method according to claim 17, wherein a type of the target information block indicated by the type information of the target information block comprises at least one of the following:
a start information block, wherein the start information block is an earliest information block of the at least one information block;
an end information block, wherein the end information block is a latest information block of the at least one information block; or
a middle information block, wherein the middle information block is an information block between the earliest information block and the latest information block of the at least one information block.

19. The information transmission method according to claim 13, wherein before the sending end sends the at least one information block to the receiving end, the method further comprises:
sending first configuration information to the receiving end, wherein the first configuration information is used for the receiving end to receive the at least one information block, and
the first configuration information comprises at least one of the following:
information of a first sequence comprised in some or all of the at least one information block, a splitting manner of the first data, a bit length of each information block of the at least one information block, a type of each information block of the at least one information block, monitoring time window information of the at least one information block, a total quantity of information blocks associated with the first data, index information of some or all of the at least one information block, or a first operation performed by the receiving end based on a reception situation of the at least one information block.

20. A receiving end, comprising a processor and a memory storing instructions, wherein the instructions, when executed by the processor, cause the processor to perform operations comprising:
receiving at least one information block; and
obtaining first data based on the at least one information block, wherein
the first data comprises at least one of the following: a wake-up signal and or information of backscatter communication.
